(19) United States
(12) Patent Application Publication
(10) Pub. No.: US 2007/0253373 A1
(43) Pub. Date: Nov. 1, 2007

(54) Method of using a shared control channel in wireless communications

(76) Inventor: Sridhar Gollamudi, Morris Plains, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/413,762

(22) Filed: Apr. 27, 2006

(51) Int. Cl. H04B 7/216

(52) U.S. Cl. 370/335

(57) ABSTRACT

In an improved method for using an HSDPA control channel HS-SCCH, all k+m bits carried on the HS-SCCH are encoded together to form a single codeword, which is transmitted over the entire duration, i.e., three slots, or 2 ms, of the transmission time interval TTI. At the receiving end, the user will receive, within the first slot, only a partial codeword. The user will make an inference whether it is the intended recipient of the corresponding transmission on the downlink shared channel. If the user determines that it is, indeed, the intended recipient, it buffers the HS-PDSCH signal and receives the remaining part of the HS-SCCH transmission.

### ART BACKGROUND

HSDPA is a high-speed packet data transmission system for the downlink, i.e., the link from the base station to the mobile station, in a wireless communication system. The current implementation of HSDPA is defined in Release 5 of the UMTS specification published by the 3^{rd} Generation Partnership Project (3GPP).

In HSDPA, a group of users is scheduled in each transmission time interval (TTI), which is 2 ms long. That is, within the 2 ms duration of a given TTI, a scheduler in the base station selects a small number of users, typically up to eight, to which data is to be transmitted in that 2-ms interval. In the next 2-ms interval, the scheduler may select another group of users to whom to transmit. Data is transmitted to each of the scheduled users via a physical channel called the HS-PDSCH (High-Speed Physical Downlink Shared Channel).

Users do not receive advance notice of particular TTIs in which they will be scheduled. Because a given, scheduled user lacks such advance knowledge, the base station must let the scheduled user know that a particular transmission is meant for him. In HSDPA, this is achieved using a control channel called HS-SCCH (High-Speed Shared Control Channel). At any given time, each scheduled user will be served by a distinct HS-SCCH channel. The various HS-SSCH channels are distinguished by having different spreading codes. In current implementations, these spreading codes are OVSF (Orthogonal Variation Spreading Factor) codes.

The HS-SCCH channel contains the unique identity of the user who is scheduled, along with several parameters that the user will need in order to decode the received transmission. Such parameters may include, e.g., the data rate at which traffic is transmitted to the user on the HS-PDSCH, and the modulation used for HS-PDSCH. Before receiving any scheduled transmission, the user must first decode the HS-SCCH channel in order to ascertain whether he is scheduled, and also to decode the parameters from the HS-SCCH that he will need to decode the corresponding data traffic from HS-PDSCH.

The HS-SCCH carries a total number k of bits that contain control information required to decode HS-PDSCH, and a total number m of bits that represent a unique user identity. These k+m bits are encoded to form a total of 120 coded bits that are transmitted over the air. In current implementations, this coding is done using a convolutional code.

The 120 coded HS-SCCH bits are transmitted in a transmission time interval (TTI) of 2 ms duration. Each TTI is made up of three UMTS time slots, each of which is 0.667 ms long. The timing relationship between an HS-SCCH transmission and the corresponding data transmission on the HS-PDSCH is shown in FIG. 1.

As seen in the figure, HS-SCCH transmission time interval 10 is made up of time slots 11, 12, and 13, and HS-PDSCH transmission time interval 20 is made up of time slots 21, 22, and 23. As further seen in the figure, HS-SCCH 10 is transmitted two time slots ahead of the beginning of the data transmission on HS-PDSCH 20.

In the current specification of HSDPA, the HS-SCCH message, consisting of k+m bits, is broken into two parts. Each part is independently encoded, so that two separate codewords are created. The first codeword is transmitted in slot 1 of the HS-SCCH transmission time interval, such as in slot 11 of FIG. 1, and the second codeword is transmitted in slots 2 and 3 of the same TTI, such as in slots 12 and 13 of FIG. 1.

The user will receive the first part of the HS-SCCH transmission during slot 11 (after transmission delay). Before the beginning of the corresponding HS-PDSCH transmission time interval, the user will decode the first part of the HS-SCCH transmission to determine whether he is the intended recipient of the corresponding transmission on the downlink shared channel. If he is, in fact, the intended recipient, the user will start buffering the HS-PDSCH signal from the beginning of the HS-PDSCH transmission time interval, and he will also decode the second part of the HS-SCCH message to obtain further control information. If decoding of the first part of the HS-SCCH message reveals that the user is not the intended recipient, then he does not need to decode the second part, nor does he need to buffer the HS-PDSCH signals.

Although the method described above for using the control channel is useful, there is a need for further improvements, particularly those which reduce power requirements.

### SUMMARY OF THE INVENTION

We have found an improved method for using the control channel. In at least some cases, our method will lead to reduced power requirements.

In accordance with our new method, all k+m bits carried on the HS-SCCH are encoded together to form a single codeword, which is transmitted over the entire duration, i.e., three slots, or 2 ms, of the TTI. At the receiving end, the user will receive, within the first slot, only a partial codeword. The user will make an inference whether it is the intended recipient of the corresponding transmission on the downlink shared channel. If the user determines that it is, indeed, the intended recipient, it buffers the HS-PDSCH signal and receives the remaining part of the HS-SCCH transmission.

In specific embodiments, the user terminal has access to, e.g. by storing them, a collection of candidate codewords. Each candidate codeword is a partial codeword known to relate specifically to that particular user terminal. The inference is made by correlating the received partial codeword with the candidate vectors. If a measure of correlation exceeds a threshold, that user terminal is deemed to be the intended recipient.

### BRIEF DESCRIPTION OF THE DRAWING

FIG. 1 is an HSDPA timing diagram corresponding to methods of the prior art.

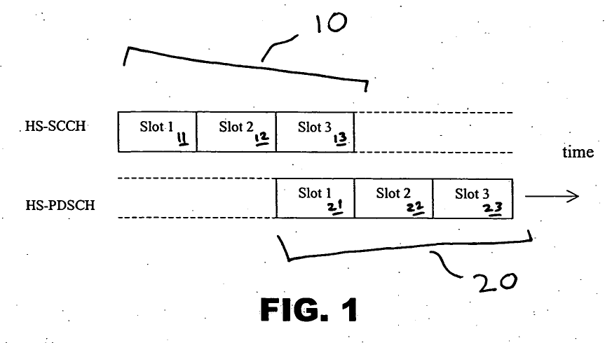

FIG. 2 is a flowchart illustrating the new method described here, in an exemplary embodiment.

### DETAILED DESCRIPTION

According to our new method, all k+m bits carried on the HS-SCCH are encoded together to form a single codeword, which is transmitted over the entire 2-ms, or three-slot, duration of the TTI. This would imply that the user will have to wait until the end of the HS-SCCH TTI in order to decode HS-SCCH information. However, the HS-PDSCH transmission would have already begun by then. Consequently, the user cannot wait to decode the HS-SCCH before buffering HS-PDSCH signals. We have resolved this problem by providing a way for the user to detect whether this transmission is intended for him, without waiting to receive the whole codeword from HS-SCCH.

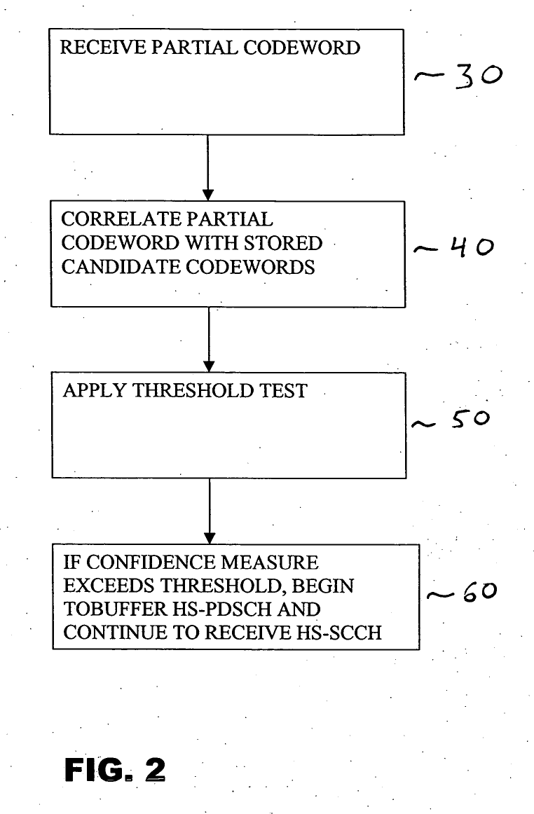

At the end of slot 1 of the HS-SCCH, the user will have received only a part of the entire HS-SCCH codeword, as indicated at block 30 of FIG. 2. He will, for example, have received only 40 of a total of 120 coded bits. Below, we will describe an algorithm for determining whether the transmission was intended for a particular user, based only on noisy observations of this partial codeword.

As mentioned above, the message carried by HS-SCCH is derived from m bits of user identity and k bits of other control information. As far as a particular user is concerned, his user identity is a fixed and known quantity. Therefore, the total number of all possible codewords that may be intended for this user is 2^{k}.

The set of 2^{k} possible codewords intended for this user will be extremely unlikely to overlap the set intended for any other user, because the output of the convolutional, or other, function that creates the codeword is also dependent on the m input bits that specify user identity. Accordingly, the user lists all these 2^{k} different codewords and stores only the portions of these codewords that correspond to slot 1 of the HS-SCCH transmission. Although these partial codewords will typically be stored at the user terminal, they may alternatively be stored in a separate but accessible location.

We denote the ith partial codeword by a vector cᵢ, where i can range from 1 to 2^{k}.

After reception of slot 1 of the HS-SCCH transmission, the user has a noisy version of the partial codeword, which we denote by a vector y. As indicated at block 40 of FIG. 2, the user computes a correlation of the received partial codeword with the stored partial codewords. In one possible approach, the user computes the correlation of the received partial codeword y with each of the stored partial codewords, cᵢ to obtain correlations rᵢ, as follows:

$${r}_{i} = 〈 y , {c}_{i} 〉 = {\sum }_{n} y ( n ) {c}_{i} ( n ) ,$$

where y(n) is the nth element of the vector y.

The user then selects the maximum value of these correlation values, which we denote by rₘₐₓ=maxᵢrᵢ. This maximum correlation (rₘₐₓ) is a measure of the confidence that this transmission was intended for this user. As indicated at block 50 of FIG. 2, the confidence measure rₘₐₓ is compared to a pre-defined threshold T to decide whether the transmission was intended for the user. In other words, the user will decide that the transmission was intended for him if rₘₐₓ>T, and otherwise decide that it was not intended for him.

The user performs this test after, e.g., receiving slot 1 of the HS-SCCH transmission and before the beginning of, e.g., slot 1 of the corresponding HS-PDSCH. If the user decides that this transmission is not intended for him then he does not need to buffer the HS-PDSCH signals or receive the remainder of the HS-SCCH transmission. However, as indicated at block 60 of FIG. 2, the user will begin buffering the HS-PDSCH signals and will continue to receive the HS-SCCH transmission if the confidence measure exceeds the threshold.

It will be understood that various other methods of computing a confidence measure may be used without departing from the spirit and scope of the present invention. For example, the confidence measure may be evaluated using trellis-based algorithms such as those used in the Viterbi algorithm, although such approaches will generally be most applicable when the number of possible codewords is very large.

It will also be understood that although the invention has been described with particular reference to HSDPA systems, such reference is purely for purposes of illustration and is not meant to limit the scope of the invention.

What is claimed is:

1. A method, comprising:
at a communication terminal, receiving a portion of a codeword transmitted over a control channel, wherein said codeword contains information indicating the identity of a terminal scheduled to receive a transmission on a shared channel;
inferring from said codeword portion whether the communication terminal is the scheduled terminal; and
if the communication terminal is the scheduled terminal, commencing to receive the transmission.

2. The method of claim 1, wherein said inferring step comprises computing a confidence measure by correlating the codeword portion with a collection of candidate codewords, and inferring that the communication terminal is the scheduled terminal if the confidence measure exceeds a threshold.

3. The method of claim 2, wherein a respective correlation is computed between the codeword portion and each of the candidate codewords, and the confidence measure is the greatest of the computed correlations.

4. The method of claim 1, wherein the codeword occupies three timeslots, and the codeword portion is received in the first of the three timeslots.
